(19) United States
(12) Patent Application Publication
(10) Pub. No.: US 2021/0048203 A1
(43) Pub. Date: Feb. 18, 2021

(54) HEAT PUMP SYSTEM WITH RAINWATER CISTERN

(71) Applicant: Melink Solar & Geo, Inc., Milford, OH (US)

(72) Inventors: Steve Melink, Cincinnati, OH (US); Steve Hamstra, Zeeland, MI (US)

(21) Appl. No.: 16/991,345

(22) Filed: Aug. 12, 2020

Related U.S. Application Data
(60) Provisional application No. 62/885,431, filed on Aug. 12, 2019.
(60) Provisional application No. 62/938,380, filed on Nov. 21, 2019.

(51) Int. Cl. F24F 5/00

(52) U.S. Cl. CPC F24F 5/0017; F24F 2005/0025; F24F 5/001

(57) ABSTRACT

An exemplary system includes a rainwater cistern and a first heat pump loop configured to transfer thermal energy between water stored in the cistern and an indoor medium. The first heat pump loop may further be configured to selectively transfer thermal energy between the indoor medium and an outdoor medium. Additionally or alternatively, the system may further comprise a second heat pump loop configured to transmit thermal energy between the stored water and the outdoor medium. In certain embodiments, the system may include a spray system operable to spray collected water over the roof of a building.

### CROSS-REFERENCE TO RELATED APPLICATIONS

The present application claims the benefit of US Provisional Patent Application No. 62/885,431, filed Aug. 12, 2019, and U.S. Provisional Patent Application No. 62/938,380, filed Nov. 21, 2019, the contents of each of which are incorporated by reference in their entirety.

### TECHNICAL FIELD

The present disclosure generally relates to heating, ventilation, and air conditioning (HVAC) systems, and more particularly but not exclusively relates to systems and methods of operating heat pump systems using collected rainwater as a heat sink/source.

### BACKGROUND

Conventional HVAC systems typically utilize an air-source refrigeration loop in which heat is rejected from the refrigerant loop via an outdoor condenser. However, such conventional systems can suffer from drawbacks, including those related to efficiency. In warm climates, for example, rejecting heat to the warm outdoor air can result in suboptimal efficiency for the HVAC system. For these reasons among others, there remains a need for further improvements in this technological field.

### SUMMARY

An exemplary system includes a rainwater cistern and a first heat pump loop configured to transfer thermal energy between water stored in the cistern and an indoor medium. The first heat pump loop may further be configured to selectively transfer thermal energy between the indoor medium and an outdoor medium. Additionally or alternatively, the system may further comprise a second heat pump loop configured to transmit thermal energy between the stored water and the outdoor medium. In certain embodiments, the system may include a spray system operable to spray collected water over the roof of a building. Further embodiments, forms, features, and aspects of the present application shall become apparent from the description and figures provided herewith.

### BRIEF DESCRIPTION OF THE FIGURES

FIG. 1 is a schematic diagram of a system according to certain embodiments.

FIG. 2 is a schematic block diagram of a system according to certain embodiments.

FIG. 3 is a schematic flow diagram of a process according to certain embodiments.

FIG. 4 is a schematic block diagram of a computing device that may be utilized in certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

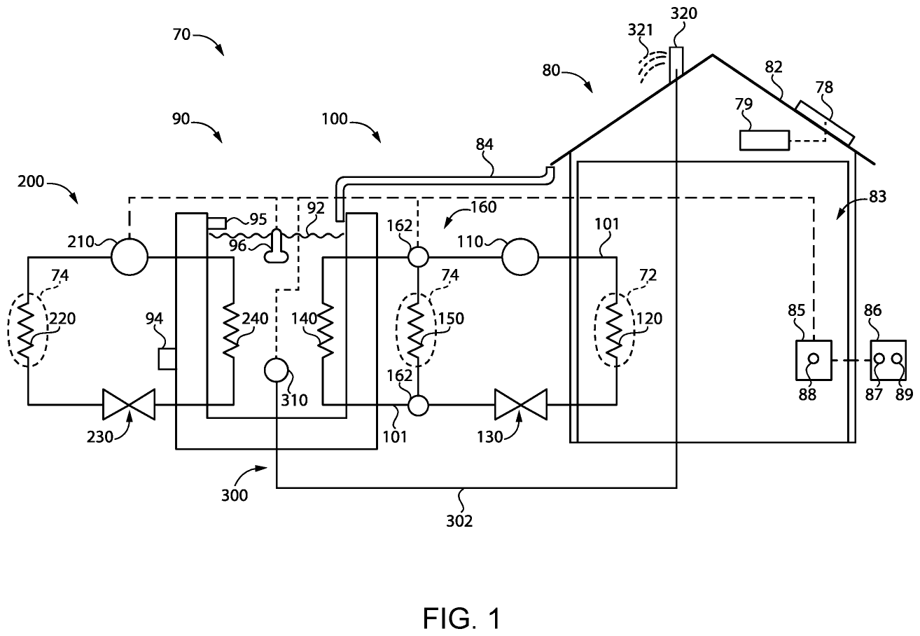

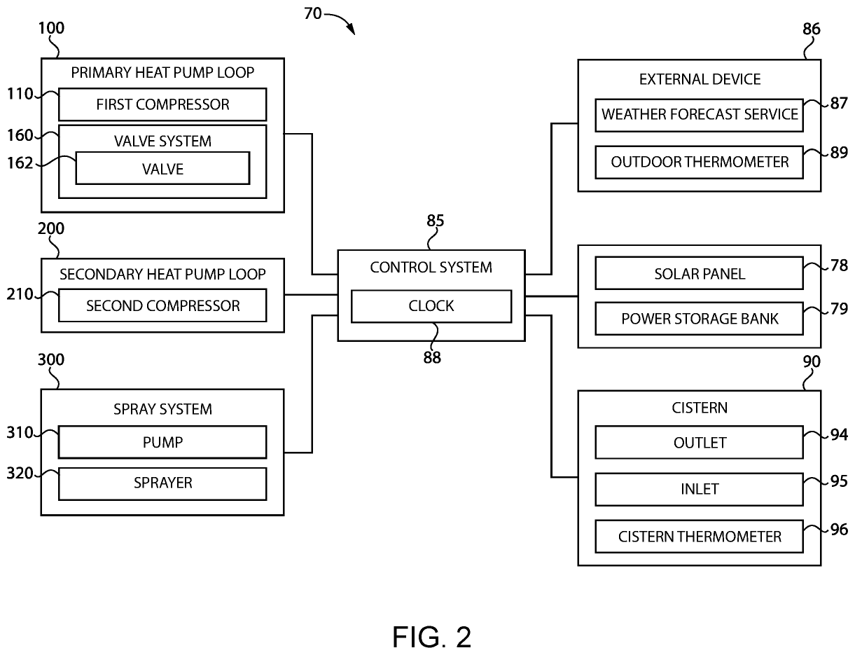

With reference to FIGS. 1 and 2, illustrated therein is a system 70 for a building 80 having a rainwater cistern 90 in the vicinity thereof. The system 70 generally includes a primary heat pump loop 100 operable to transfer thermal energy between an indoor medium 72 within the building 80 and water 92 stored in the cistern 90. As described herein, the primary heat pump loop 100 may further be operable to transfer thermal energy between the indoor medium 72 and an outdoor medium 74. In certain embodiments, the system 70 may further include a secondary heat pump loop 200 operable to transfer thermal energy between the outdoor medium 74 and the stored water 92. Additionally or alternatively, the system 70 may include a spray system 300 operable to spray water onto the roof 82 of the building 80.

In certain embodiments, the system 70 may include a solar panel 78 (e.g., one or more photovoltaic cells) installed to the roof 82 or elsewhere on the premises, and may further include a power storage bank 79 that stores electrical power generated by the solar panel 78. In certain embodiments, the solar panel 78 may serve as a dedicated power source for the system 70 in order to reduce the amount of power the system 70 draws from the grid. For example, the power generated by the solar panel 78 (and optionally stored in the power bank 79) may be used during peak hours to reduce peak demand of the system 70. It is also contemplated that the power generated by the solar panel 78 may be used to power the system 70 during off-peak hours.

The building 80 has an indoor area 83 positioned below the roof 82. One or more downspouts 84 extend from gutters of the roof 82 to the cistern 90 such that the rainwater falling on the roof 82 is collected in the gutters and directed to the cistern 90 by the downspout(s) 84. The building 80 also includes a control system 85 operable to control operation of the primary heat pump loop 100. In embodiments that include the secondary heat pump loop 200 and/or the spray system 300, the control system 85 may also control operation of the secondary heat pump loop 200 and/or the spray system 300. As described herein, the control system 85 includes a clock 88, and may be in communication with an external device 86, such as a weather forecast service 87, an outdoor thermometer 89, and/or a cistern thermometer 96.

The cistern 90 is operable to store collected water 92, and includes an outlet 94, an inlet 95, and a thermometer 96, one or more of which may be in communication with the control system 85. In the illustrated form, the cistern 90 is provided as an above-ground cistern, and the outlet 94 can be used to drain water 92 from the cistern 90. It is also contemplated that the cistern 90 may be provided as an in-ground cistern, and that the cistern 90 may include a pump operable to discharge collected water 92. The inlet 95 may be connected to a mains water supply such that the cistern 90 can be at least partially filled with cool mains water. In certain embodiments, the outlet 94 and/or the inlet 95 may operate under control of the control system 85. The cistern thermometer 96 is operable to detect the temperature of the stored water 92 and to transmit to the control system 85 information related to the temperature of the stored water 92.

The primary heat pump loop 100 has a first refrigerant flowing therethrough and is configured to transfer thermal energy between the stored water 92 and the indoor medium 72. The primary heat pump loop 100 generally includes a compressor 110 operable to compress the refrigerant, an indoor heat exchanger 120 in thermal communication with the indoor medium 72, a first expander 130 operable to expand the refrigerant, and a first cistern heat exchanger 140 positioned in the cistern 90 and in thermal communication with the stored water 92. As will be appreciated, the compressor 110, the indoor heat exchanger 120, the expander 130, and the cistern heat exchanger 140 are connected in series via conduits 101 such that refrigerant flows through the first heat pump loop 100 in a vapor-compression cycle. In certain forms, the refrigerant may be water such that leakage does not contaminate the stored water 92 and/or the environment. It is also contemplated that the refrigerant may be of another type, such as R-22 or R-410A.

The heat pump loop 100 may further include an outdoor heat exchanger 150, which may be connected in parallel with the indoor heat exchanger 120, and a valve assembly 160 including valves 162 operable to selectively direct the refrigerant through the cistern heat exchanger 140 and/or the outdoor heat exchanger 150. In certain embodiments, the outdoor heat exchanger 150 may be provided as an above-ground heat exchanger such that the outdoor medium 74 comprises air. In certain embodiments, the outdoor heat exchanger 150 may be located in a stream or pond such that the outdoor medium 74 comprises water. In certain embodiments, the outdoor heat exchanger 150 may be provided as an in-ground heat exchanger such that the outdoor medium 74 comprises earth.

The valve assembly 160 may have a first configuration in which the valve(s) 162 direct the refrigerant through the cistern heat exchanger 140 and block the refrigerant from flowing through the outdoor heat exchanger 150, and a second configuration in which the valve(s) 162 direct the refrigerant through the outdoor heat exchanger 150 and block the refrigerant from flowing through the cistern exchanger 140. The valve assembly 160 may have a third configuration in which a portion of the refrigerant is directed through the cistern heat exchanger 140 and the remainder of the refrigerant is directed through the outdoor heat exchanger 150.

As is typical with heat pump loops, the heat pump loop 100 is configured to operate in a vapor compression cycle in which the refrigerant flows from the compressor 110 to a condenser, then through the expander 130 and an evaporator, and subsequently returns to the compressor 110. As described herein, the heat pump loop 100 operates under control of the control system 85, and is operable in at least one cooling mode in which the heat pump loop 100 cools the indoor medium 72 and/or at least one heating mode in which the heat pump loop 100 heats the indoor medium 72. In one or more of the cooling modes, the cistern heat exchanger 140 serves as the condenser such that the stored water 92 serves as a heat sink for the heat pump loop 100. In one or more of the heating modes, the cistern heat exchanger 140 serves as the evaporator such that the stored water 92 serves as a heat source for the heat pump loop 100.

As described herein, the primary heat pump loop 100 is configured to transmit thermal energy between the stored water 92 and an indoor medium 72. In certain embodiments, the indoor medium 72 may be one that is directly used by the occupants of the building, such as the air of the indoor space 83 and/or domestic water in a holding tank. Additionally or alternatively, the indoor medium 72 may be provided as an indirect carrier medium, such as the refrigerant of a building heat pump loop (not illustrated). The primary heat pump loop 100 may have a cooling mode in which the heat pump loop 100 cools the indoor medium 72 by transferring thermal energy from the indoor medium 72 to the stored water 92 such that the stored water 92 acts as a heat sink. The heat pump loop 100 may additionally or alternatively have a heating mode in which the heat pump loop 100 heats the indoor medium 72 by transferring thermal energy to the indoor medium 72 from the stored water 92 such that the stored water 92 acts as a heat source.

In certain embodiments, the primary heat pump loop 100 is further configured to transmit thermal energy between the indoor medium 72 and an outdoor medium 74, such as the outdoor air and/or the ground. In such forms, the heat pump loop 100 may have a second cooling mode in which the heat pump loop cools the indoor medium 72 by transferring thermal energy from the indoor medium 72 to the outdoor medium 74, and/or a second heating mode in which the heat pump loop 100 heats the indoor medium 72 by transferring thermal energy to the indoor medium 72 from the outdoor medium 74.

As noted above, the heat pump loop 100 may have a first cooling mode. In the first cooling mode, the valve system 160 is operated such that the refrigerant proceeds from the compressor 110 to the cistern heat exchanger 140, through the expander 130 to the indoor heat exchanger 120, and subsequently returns to the compressor 110. Thus, refrigerant exiting the compressor 110 is discharged to the cistern heat exchanger 140, which acts as the condenser in the first cooling mode. More particularly, heat is rejected from the refrigerant to the stored water 92 such that the stored water 92 serves as a heat sink for the heat pump loop 100. The refrigerant proceeds from the cistern heat exchanger 140 through the expander 130 and into the indoor heat exchanger 120, which acts as an evaporator such that the refrigerant accepts heat to cool the indoor medium 72.

The heat pump loop 100 may additionally have a second cooling mode, in which the valve system 160 is operated such that refrigerant proceeds from the compressor 110 to the outdoor heat exchanger 150, through the expander 130 to the indoor heat exchanger 120, and subsequently returns to the compressor 110. Thus, refrigerant exiting the compressor 110 is discharged to the outdoor heat exchanger 150, which acts as the condenser in the second cooling mode. More particularly, heat is rejected from the refrigerant to the outdoor medium 74 such that the outdoor medium 74 serves as a heat sink for the heat pump loop 100. The refrigerant proceeds from the outdoor heat exchanger 150 through the expander 130 and into the indoor heat exchanger 120, which acts as an evaporator such that the refrigerant accepts heat to thereby cool the indoor medium 72.

In addition or as an alternative to the cooling mode(s), the heat pump loop 100 may have a first heating mode. In the first heating mode, the valve system 160 is operated such that refrigerant proceeds from the compressor 110 to the indoor heat exchanger 120, through the expander 130 to the cistern heat exchanger 140, and subsequently returns to the compressor 110. Thus, refrigerant exiting the compressor 110 is discharged to the indoor heat exchanger 120, which acts as the condenser in the first heating mode. More particularly, heat is rejected from the refrigerant to the indoor medium 72 such that the heat pump loop 100 warms the indoor medium 72. The refrigerant proceeds from the indoor heat exchanger 120 through the expander 130 and into the cistern heat exchanger 140 (acting as an evaporator), where the refrigerant accepts heat from the stored water 92 such that the stored water 92 serves as a heat source in the first heating mode.

The heat pump loop 100 may additionally have a second heating mode, in which the valve system 160 is operated such that refrigerant proceeds from the compressor 110 to the indoor heat exchanger 120, through the expander 130 to the outdoor heat exchanger 150, and subsequently returns to the compressor 110. Thus, refrigerant exiting the compressor 110 is discharged to the indoor heat exchanger 120, which acts as the condenser in the second heating mode. More particularly, heat is rejected from the refrigerant to the indoor medium 72 such that the heat pump loop 100 warms the indoor medium 72. The refrigerant proceeds from the indoor heat exchanger 120 through the expander 130 and into the outdoor heat exchanger 150 (acting as an evaporator), where the refrigerant accepts heat from the outdoor medium 74 such that the outdoor medium 74 serves as a heat source in the second heating mode.

As should be evident from the foregoing, the illustrated primary heat pump loop 100 is operable in at least one heating mode in which the refrigerant flows in a first direction (clockwise in FIG. 1) and at least one cooling mode in which the refrigerant flows in an opposite second direction (counter-clockwise in FIG. 1). In certain forms, the compressor 110 may be reversible to effect this reversal of flow directions. Additionally or alternatively, the valve system 160 may include additional valves that provide for this reversal of flow directions. In other embodiments, the primary heat pump loop 100 may be operable in only the cooling mode(s), while in further embodiments, the primary heat pump loop 100 may be operable in only the heating mode(s).

Furthermore, the illustrated heat pump loop 100 is configured to selectively operate as a water-source heat pump (e.g., when operating in the first cooling mode and/or the first heating mode) and as an air-source or geothermal heat pump (e.g., when operating in the second cooling mode and/or the second heating mode). It is also contemplated that the outdoor heat exchanger 150 may be omitted such that the heat pump loop 100 operates solely as a water-source heat pump loop. In certain forms, a tertiary heat pump loop may be provided with an outdoor heat exchanger.

In embodiments that include the secondary heat pump loop 200, the secondary heat pump loop 200 has a second refrigerant flowing therethrough and is operable to transfer thermal energy between the stored water 92 and the outdoor medium 74. In certain embodiments, the first refrigerant and the second refrigerant may be of the same type, while in other embodiments, the first refrigerant and the second refrigerant may be of different types. The secondary heat pump loop 200 generally includes a second compressor 210 operable to compress the second refrigerant, a secondary outdoor heat exchanger 220 in thermal communication with the outdoor medium 74, a second expander 230 operable to expand the second refrigerant, and a secondary cistern heat exchanger 240 positioned in the cistern 90 and in thermal communication with the stored water 92. In certain embodiments, the outdoor heat exchanger 220 may be provided as an above-ground heat exchanger. Additionally or alternatively, the outdoor heat exchanger 220 may be provided as an in-ground heat exchanger, such as a geothermal heat exchanger. As described herein, the secondary heat pump loop 200 operates under control of the control system 85, and is configured to heat the stored water 92 in a regenerative heating mode and/or to cool the stored water 92 in a regenerative cooling mode.

In the regenerative heating mode, the secondary heat pump loop 200 is operated such that refrigerant proceeds from the compressor 210 to the secondary cistern heat exchanger 240, through the expander 230 to the secondary outdoor heat exchanger 220, and subsequently returns to the compressor 210. Thus, in the regenerative heating mode, the outdoor heat exchanger 220 serves as the evaporator and the cistern heat exchanger 240 serves as the condenser such that the secondary heat pump loop 200 heats the stored water 92.

In the regenerative cooling mode, the secondary heat pump loop 200 is operated such that refrigerant proceeds from the compressor 210 to the secondary outdoor heat exchanger 220, through the expander 230 to the secondary cistern heat exchanger 240, and subsequently returns to the compressor 210. Thus, in the regenerative cooling mode, the outdoor heat exchanger 220 serves as the condenser and the cistern heat exchanger 240 serves as the evaporator such that the secondary heat pump loop 200 chills the stored water 92.

As should be evident from the foregoing, the secondary heat pump loop 200 is operable in at least one mode in which the refrigerant flows in a first direction (clockwise in FIG. 1) and at least one mode in which the refrigerant flows in an opposite second direction (counter-clockwise in FIG. 1). In certain forms, the compressor 210 may be reversible to effect this reversal of flow directions. Additionally or alternatively, the heat pump loop 200 may include a valve system that provides for reversal of flow directions. In some embodiments, the secondary heat pump loop 200 may be operable in only the regenerative cooling mode, while in further embodiments, the secondary heat pump loop 200 may be operable in only the regenerative heating mode.

The secondary heat pump loop 200 may operate in conjunction with the primary heat pump loop 100 to increase the overall cost-efficiency of the system 70. For example, during seasons in which the primary heat pump loop 100 is primarily operated in the first cooling mode, the stored water 92 may become warm enough that the efficiency of the primary heat pump loop 100 is adversely affected. In such cases, the secondary heat pump loop 200 may be operated to reduce the temperature of the stored water 92, thereby increasing the efficiency of the primary heat pump loop 100. As another example, during seasons in which the primary heat pump loop 100 is primarily operated in the first heating mode, the stored water 92 may become cool enough that the efficiency of the primary heat pump loop 100 is adversely affected. In such cases, the secondary heat pump loop 200 may be operated to increase the temperature of the stored water 92, thereby increasing the efficiency of the primary heat pump loop 100. As described herein, the operation of the secondary heat pump loop 200 may be restricted to off-peak hours, during which times power costs are typically reduced.

In embodiments that include the spray system 300, the spray system 300 generally includes a pump 310 positioned in the cistern 90 and a sprayer 320 that is positioned on the roof 82 and is connected with the pump 310 via a feed line 302. The spray system 300 may operate under control of the control system 85 to spray collected water 92 over the roof 82 such that the sprayed water 321 accepts or rejects heat as the water flows over the roof 82. The sprayed water 321 is then returned to the cistern 90 via the downspout 84 to raise or lower the average temperature of the stored water 92.

The control system 85 is in communication with the electrically-operable components of the cistern 90, the primary heat pump loop 100, the secondary heat pump loop 200, and the spray system 300 such that the control system 85 is operable to control operation of the cistern 90, the primary heat pump loop 100, the secondary heat pump loop 200, and the spray system 300. The control system 85 may further be in communication with an external device 86 such that the control system 85 is operable to make control decisions based at least in part upon information received from the external device 86. This control may be based at least in part upon one or more of the following: weather forecast information that may be received from the weather forecast service 87; seasonal information, day-of-week information, and/or time-of-day information that may be received from the clock 88; outdoor temperature information that may be received from the weather forecast service 87 and/or the outdoor thermometer 89; and cistern water temperature information that may be received from the cistern thermometer 96. Certain example embodiments of the control provided by the control system 85 are provided herein.

During summer days in certain climates, the ambient temperatures can easily reach 95° F. outside. While certain conventional air conditioning systems use this hot ambient air to cool indoor spaces, it is inefficient to reject heat from these internal spaces into an even warmer space—the outside air. In the illustrated embodiment, however, the cistern 90 is utilized to collect rainwater from the roof 82, which rainwater may have a temperature on the order of 20° F. cooler than the outside air temperature. It is much more energy efficient to reject heat from the inside medium 72 into a cooler medium such as the collected rainwater 92 than into a warmer medium like outside air. Those skilled in the art will readily appreciate that as heat is rejected into the collected water 92, the temperature of the water 92 will increase over time. As such, when it finally reaches the same temperature as the outside air temperature (or is within a predetermined range of the outside air temperature), this warmer water can either be discharged for landscaping or grey water purposes, slowly released into the storm-water system, or cooled for further use. The next time it rains, the process will repeat itself. During long spells with no rain, the heat pump loop 100 may operate in the second cooling mode in which it operates as an air-source (or geothermal) heat pump to control the temperature in the indoor space 83 (and/or of the indoor medium 72). Additionally or alternatively, cool domestic water may be used to refill the cistern 90 and use it in the same way as rainwater 92: to first use it as a heat source/sink before using it for landscaping or grey water.

The system 70 may also utilize certain intelligence such as a weather forecast (e.g., from the weather forecast service 87) to plan the appropriate and most energy-efficient strategy for the above range of equipment. For example, if the weather forecast calls for rain on Tuesday, then it may be suboptimal to refill the cistern 90 with domestic water on Monday; it may instead be preferable to operate the heat pump loop 100 in the second cooling mode until it rains, at which point the control system 85 may return the heat pump loop 100 to operation in the first cooling mode. As another example, if a heat wave is predicted for the coming days, the control system 85 may operate the secondary heat pump loop 200 in the regenerative cooling mode to chill the stored water 92 before the heat wave arrives, as operating in the regenerative cooling mode may be less efficient during the warmer temperatures, particularly in embodiments in which the secondary heat pump loop 200 is provided as an air-source heat pump loop for which the outdoor medium 72 is ambient air.

It may also be desirable to extend the useful life of the stored water 92 by using the spray system 300. For example, during nighttime hours, at least a portion of the stored water 92 may be pumped to the roof 82 via the pump 310 and sprayed via the sprayer 320 across the surface of the roof 82, where evaporative cooling and mixing with the natural dew reduce the temperature of the sprayed water 321. In such forms, the water returning via the downspout(s) 84 will gradually lower the average temperature of the stored water 92 in the cistern 90 so that it can be used the next day for air conditioning in the first cooling mode. This is in contrast to conventional cooling towers, which operate during the day to satisfy instantaneous needs and are therefore less efficient because they are dealing with higher daytime temperatures.

In certain embodiments, the cold condensate water generated on the heat exchanger serving as the evaporator may be routed back to the cistern 90. Typically, this condensate water is discharged to the sewer system as another waste stream, when in fact it may be colder than the stored water 92, in which case it may be used to help lower the average temperature of the water 92 stored in the cistern 90.

As noted above, in certain embodiments, the secondary heat pump loop 200 may be used to control the temperature of the water 92 inside the cistern 90. One benefit of such use is that the air-water heat pump loop 200 could operate during off-peak hours (e.g., nights and/or weekends) rather than during the weekday peak hours. In such forms, the high volume of stored water 92 in the cistern 90 would serve as a thermal storage battery for the building 80. One reason this may be desirable is that nighttime temperatures are usually significantly cooler than during daytime hours, thereby providing increased efficiency for cooling of the stored water 82, particularly in embodiments in which the secondary heat pump loop 200 is provided as an air-source heat pump loop for which the outdoor medium 72 is ambient air.

Additionally, an increasing number utilities are offering time-of-day energy pricing to encourage the use of more appliances at night in order to reduce their peak demand. Thus, the secondary heat pump loop 200 may be operated during off-peak hours (e.g., nights and/or weekends) to store thermal energy that can then be used during peak hours. The control system 85 may, for example, determine when to operate the secondary heat pump loop 200 based on the time of day (e.g., during nighttime hours) and/or the day of the week (e.g., during weekends). This time-of-day and day-of-week information may be received from the clock 88.

In certain markets, the summer season sees rain virtually every afternoon, with rain frequently occurring in the spring and fall seasons. Since most buildings are cooling-dominant (meaning they need cooling even in the spring and fall), the subject matter described herein could serve a large swath of the United States and other parts of the world. The addition of an air-water heat pump mode such as the second cooling mode (or a tertiary heat pump system providing similar functionality) would complement the system 70 so that cooling could still be provided even when there is little or no rain. Even in such circumstances, however, the roof spray cooling system 300 may be utilized and/or domestic water may be provided to the cistern 90 (e.g., via the inlet 95) to supplement the collection of rainwater in the cistern 90, thereby providing for cooling even during a drought period.

As should be appreciated, the subject matter described herein may aid in bringing the advantages of geothermal-type heating and cooling to the masses by making it lower cost and more affordable. Unfortunately, only about 3% of the HVAC market is using geothermal systems, despite the fact that it is the most efficient way to heat and cool buildings. One reason for this paucity of geothermal systems is that the cost of drilling and excavating to install the ground loop (in-ground heat exchanger) is almost prohibitive for the average building owner because of the first-cost mindset. The present system 70 may facilitate the elimination of the ground loop but gain similar temperature advantages by using the stored rainwater 92 in place of earth. The ground temperature is typically 55° F. to 75° F. depending on location, and rainwater can be almost as cool depending on the time of year.

While the illustrated cistern 90 is provided as an above-ground cistern 90, it is also contemplated that the cistern 90 may be provided as an in-ground cistern. It is also contemplated that the cistern 90 may be replaced by another form of water-retaining device, such as a retention pond. However, it has been found that the cistern 90 may provide for certain advantages over traditional retention ponds. As one example, the cistern 90 is smaller and more feasible to install in many locations. For example, when a particular property may not necessarily have the acreage required to provide a full retention pond, the smaller cistern 90 may fit within the space provided by the property. Additionally, in certain embodiments, the cistern 90 may be provided as a modular construct in which the first cistern heat exchanger 140 and optionally the second heat exchanger 240 are installed to the cistern 90 prior to installation of the cistern 90 to the property. Such a modular cistern may facilitate installation and/or reduce the installation costs.

Another potential advantage of the cistern 90 over retention ponds is the relative ease with which the cistern 90 may be emptied. Emptying of the cistern 90 may, for example, take place based upon the temperature of the stored rainwater 92 and/or the weather forecast. By way of illustration, should the temperature of the rainwater 92 exceed a setpoint on a day when the weather forecast calls for rain, the cistern 90 may be emptied of the relatively warm water 92 to make room for fresh, cooler rainwater. When emptying the cistern 90, the discharged water may be utilized for another purpose, such as irrigation of the property. A further advantage of the cistern 90 is that when a retention pond is used as a heat sink, the temperature of the pond rises. Should an excess of heat be pumped into the retention pond, the aquatic life in the retention pond may be adversely affected.

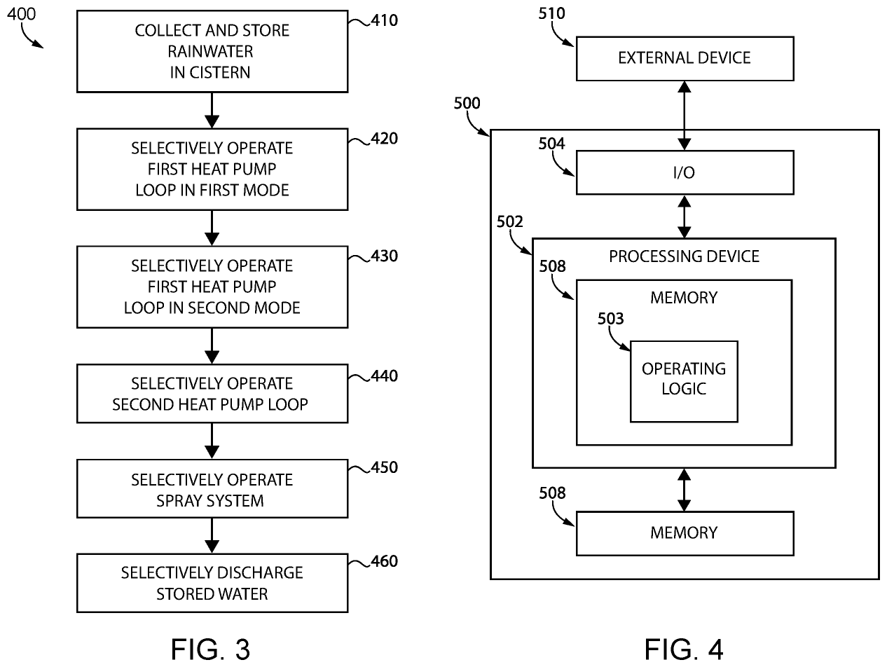

With additional reference to FIG. 3, illustrated therein is a process 400 according to certain embodiments. Blocks illustrated for the processes in the present application are understood to be examples only, and blocks may be combined or divided, and added or removed, as well as re-ordered in whole or in part, unless explicitly stated to the contrary. Unless specified to the contrary, it is contemplated that certain blocks performed in the process 400 may be performed wholly by one or more components of the system 70 (e.g., the control system 85), or that the blocks may be distributed among one or more of the elements and/or additional devices or systems that are not specifically illustrated in FIGS. 1 and 2. Additionally, while the blocks are illustrated in a relatively serial fashion, it is to be understood that two or more of the blocks may be performed concurrently or in parallel with one another.

The process 400 may begin with block 410, which generally includes collecting and storing rainwater in the cistern 90 to provide stored water 92. For example, block 410 may involve directing rainwater flowing across the roof 82 into the cistern 90 via the gutters and downspout(s) 84. Additionally or alternatively, block 410 may include operating the inlet 95 to flow mains water into the cistern 90 to supplement or be used in place of collected rainwater. In certain embodiments, block 410 may involve supplementing the collected rainwater with cool mains water, for example in the event that the stored water 92 is of a temperature too high for efficient use as a heat sink.

The process 400 includes block 420, which generally involves selectively operating the first heat pump loop 100 in a first mode to transfer thermal energy between the stored water 92 and the indoor medium 72. In certain circumstances, block 420 may involve operating the primary heat pump loop 100 in the first cooling mode to cool the indoor medium 72 using the stored water 92 as a heat sink. In other circumstances, block 420 may involve operating the primary heat pump loop 100 in the first heating mode to heat the indoor medium 72 using the stored water 92 as a heat source. As will be appreciated, the decision whether to operate the heat pump loop 100 in the heating mode or the cooling mode may be based upon a comparison of the temperature of the indoor space 83 and/or the indoor medium 72 with a setpoint, such as a setpoint set by a user operating the control system 85. The selective operation of the heat pump loop 100 in block 420 may involve selectively deactivating the heat pump loop 100 when the indoor medium 72 satisfies the setpoint.

In certain embodiments, such as those in which the primary heat pump loop 100 includes the outdoor heat exchanger 150, the process 400 may include block 430. Block 430 generally involves selectively operating the primary heat pump loop 100 in a second mode (e.g., the second cooling mode or the second heating mode) to transfer thermal energy between the indoor medium 72 and the outdoor medium 74. Block 430 may, for example, involve operating the heat pump loop 100 in the second mode when the stored water 92 is below a threshold level. Additionally or alternatively, block 430 may involve operating the heat pump loop 100 in the second mode when the stored water 92 is of a temperature too extreme (i.e., too warm or too cold) for efficient use in the first mode. Such temperature information may, for example, be received from the cistern temperature sensor 96. Additionally or alternatively, the decision whether to operate the heat pump loop 100 in the second mode may be based at least in part upon weather forecast information, such as information received from the weather forecast service 89.

In certain embodiments, such as those in which the system 70 includes the secondary heat pump loop 200, the process 400 may include block 440. Block 440 generally involves selectively operating the secondary heat pump loop 200 to transfer thermal energy between the stored water 92 and the outdoor medium 74. Block 440 may, for example, involve operating the secondary heat pump loop 200 during off-peak hours (e.g., nights and weekends) to store thermal energy in the stored water 92 to facilitate the use of the stored water 92 as a heat source/sink during peak hours (e.g., weekday daytime hours). Block 440 may further involve deactivating the secondary heat pump loop 200 during peak hours to reduce the peak energy usage of the system 70. In certain embodiments, block 440 may involve selectively operating the secondary heat pump loop based upon weather forecast information, for example as described above.

In certain embodiments, such as those in which the system 70 includes the spray system 300, the process 400 may include block 450. Block 450 generally involves selectively operating the spray system 300 to transfer thermal energy between the roof 82 and the sprayed water 321. In embodiments in which block 420 involves operating the primary heat pump loop 100 in the first cooling mode, for example, block 450 may involve operating the spray system 300 just before dawn when the roof 82 is coolest; evaporative cooling and mixing with natural dew may further increase the temperature drop of the sprayed water. In embodiments in which block 420 involves operating the primary heat pump loop 100 in the first heating mode, by contrast, block 450 may involve operating the spray system 300 in the late afternoon hours when the roof 82 is warmest and radiative heating from the sun may further increase the heat transferred to the water.

In certain embodiments, the decisions whether or not to operate the primary heat pump loop 100, the secondary heat pump loop 200, and/or the sprayer system 300 and/or the decision of how to operate the primary heat pump loop (e.g., in the first mode or in the second mode) may be interrelated. For example, if the level and/or temperature of the stored water 92 are not suitable for use of the stored water 92 in the first mode, the decision whether to operate the primary heat pump loop 100 in the second mode may depend upon the weather forecast. If the weather forecast indicates that rain is anticipated the following day, the process 400 may involve operating the primary heat pump loop 100 in the second mode (e.g., as an air-source heat pump). Should the weather forecast indicate that rain is not anticipated, the process 400 may instead involve one or more of the following: supplementing the stored water 92 with mains water to bring the stored water 92 to a level and temperature suitable for use in the first mode; operating the secondary heat pump loop 200 to bring the stored water 92 to a temperature suitable for use in the first mode; and/or operating the spray system 300 to bring the stored water 92 to a temperature suitable for use in the first mode.

The process 400 may further include block 460, which generally involves selectively discharging the stored rainwater 92 from the cistern 90. In certain forms, such as those in which the cistern 90 is provided as an above-ground cistern, block 460 may simply involve opening the outlet 94 to allow the stored rainwater 92 to flow out of the cistern 90. It is also contemplated that block 460 may involve operating a pump of the cistern 90, for example in embodiments in which the cistern 90 is provided as an in-ground cistern. Block 460 may further involve using the discharged rainwater 92 for a secondary purpose, such as irrigating the property to which the system 70 is installed.

The decision whether or not to discharge water 92 from the cistern 90 may be based upon one or more criteria, which criteria may be evaluated by the control system 85. In certain embodiments, the criteria may include a temperature of the stored water 92 and/or the weather forecast. For example, should the stored water 92 exceed a threshold value (e.g., a temperature too high for efficient use as a heat sink) on a day in which the weather forecast calls for rain above a threshold rainfall, the control system 85 may determine that it is warranted to discharge the stored rainwater 92 in anticipation of further rainfall. If no rain is in the forecast or the forecast rainfall is below the threshold rainfall, the control system 85 may instead determine that the water 92 should not be discharged, but instead should be supplied to the spray system 300 that night to aid in cooling the water 92 as described above.

In certain embodiments, the amount of water discharged from the cistern 90 may also be based on the weather forecast. For example, block 460 may involve discharging more water on days for which the weather forecast calls for a large amount of rain than on days for which the weather forecast calls for a lesser amount of rain. The amount discharged may further be based upon the collection area for the cistern 90 (e.g., the square footage of the roof 82 from which the rainwater will be collected).

In certain embodiments, the discharging of block 460 may be performed prior to the actual rainfall. Additionally or alternatively, the discharging of block 460 may be performed during the rainfall. In certain forms, block 460 may involve allowing the cistern 90 to overflow, for example via an overflow port. In certain embodiments, block 460 may involve controlling the discharge rate based upon the rate of water coming into the cistern 90. For example, the downspout(s) 84 may have disposed thereon a flow meter that measures the volumetric flowrate of the water being supplied to the cistern 90, and the control system 85 may control the outlet 94 to discharge water 92 at a similar volumetric flowrate.

While it is contemplated that block 460 may involve discharging water 92 as the cistern 90 is being filled with new rainwater, it is noted that at least partially emptying the cistern 90 prior to the rainfall may provide certain advantages. More particularly, discharging water prior to collecting additional water in the cistern 90 ensures that only the warmer water is discharged. By contrast, discharging stored water that has already mixed with the fresh rainwater results in the discharged water being of a lower temperature, which may be a waste of the thermal capacity provided by the fresh rainwater.

Although block 460 has been described primarily with reference to circumstances in which the water 92 is being used as a heat sink (and thus warms during operation), it is to be appreciated that block 460 may additionally or alternatively be performed to ensure that the stored water 92 remains efficient for use as a heat source (and thus cools during operation) and/or does not damage the cistern heat exchanger(s). For example, block 460 may involve discharging stored water when the water 92 approaches freezing to ensure that the heat exchanger 140 is not damaged by expansion as ice forms. It is also contemplated that block 460 may involve discharging stored water when the temperature of the water 92 falls below a lower threshold below which the water 92 is no longer efficient for use as a heat source. As will be appreciated, such discharge may be further based upon a weather forecast (e.g., whether the forecast predicts warmer rain to be falling that day).

Referring now to FIG. 4, a simplified block diagram of at least one embodiment of a computing device 500 is shown. The illustrative computing device 500 depicts at least one embodiment of a control system 85 that may be utilized in connection with the system 70 illustrated in FIGS. 1 and 2 and/or to perform the process 400 illustrated in FIG. 3.

Depending on the particular embodiment, the computing device 500 may be embodied as a server, desktop computer, laptop computer, tablet computer, notebook, netbook, Ultrabook™ mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 500 includes a processing device 502 that executes algorithms and/or processes data in accordance with operating logic 508, an input/output device 504 that enables communication between the computing device 500 and one or more external devices 510, and memory 506 which stores, for example, data received from the external device 510 via the input/output device 504.

The input/output device 504 allows the computing device 500 to communicate with the external device 510. For example, the input/output device 504 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Bluetooth Low Energy (BLE), Wi-Fi®, WiMAX, etc.) to effect such communication depending on the particular computing device 500. The input/output device 504 may include hardware, software, and/or firmware suitable for performing the techniques described herein.

The external device 510 may be any type of device that allows data to be inputted or outputted from the computing device 500. For example, in various embodiments, the external device 510 may be embodied as the external device 80, the primary heat pump loop 100, the secondary heat pump loop 200, and/or the spray system 300. Further, in some embodiments, the external device 510 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 510 may be integrated into the computing device 500.

The processing device 502 may be embodied as any type of processor(s) capable of performing the functions described herein. In particular, the processing device 502 may be embodied as one or more single or multi-core processors, microcontrollers, or other processor or processing/controlling circuits. For example, in some embodiments, the processing device 502 may include or be embodied as an arithmetic logic unit (ALU), central processing unit (CPU), digital signal processor (DSP), and/or another suitable processor(s). The processing device 502 may be a programmable type, a dedicated hardwired state machine, or a combination thereof. Processing devices 502 with multiple processing units may utilize distributed, pipelined, and/or parallel processing in various embodiments. Further, the processing device 502 may be dedicated to performance of just the operations described herein, or may be utilized in one or more additional applications. In the illustrative embodiment, the processing device 502 is of a programmable variety that executes algorithms and/or processes data in accordance with operating logic 508 as defined by programming instructions (such as software or firmware) stored in memory 506. Additionally or alternatively, the operating logic 508 for processing device 502 may be at least partially defined by hardwired logic or other hardware. Further, the processing device 502 may include one or more components of any type suitable to process the signals received from input/output device 504 or from other components or devices and to provide desired output signals. Such components may include digital circuitry, analog circuitry, or a combination thereof.

The memory 506 may be of one or more types of non-transitory computer-readable media, such as a solid-state memory, electromagnetic memory, optical memory, or a combination thereof. Furthermore, the memory 506 may be volatile and/or nonvolatile and, in some embodiments, some or all of the memory 506 may be of a portable variety, such as a disk, tape, memory stick, cartridge, and/or other suitable portable memory. In operation, the memory 506 may store various data and software used during operation of the computing device 500 such as operating systems, applications, programs, libraries, and drivers. It should be appreciated that the memory 506 may store data that is manipulated by the operating logic 508 of processing device 502, such as, for example, data representative of signals received from and/or sent to the input/output device 504 in addition to or in lieu of storing programming instructions defining operating logic 508. As illustrated, the memory 506 may be included with the processing device 502 and/or coupled to the processing device 502 depending on the particular embodiment. For example, in some embodiments, the processing device 502, the memory 506, and/or other components of the computing device 500 may form a portion of a system-on-a-chip (SoC) and be incorporated on a single integrated circuit chip.

In some embodiments, various components of the computing device 500 (e.g., the processing device 502 and the memory 506) may be communicatively coupled via an input/output subsystem, which may be embodied as circuitry and/or components to facilitate input/output operations with the processing device 502, the memory 506, and other components of the computing device 500. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 500 may include other or additional components, such as those commonly found in a typical computing device (e.g., various input/output devices and/or other components), in other embodiments. It should be further appreciated that one or more of the components of the computing device 500 described herein may be distributed across multiple computing devices. In other words, the techniques described herein may be employed by a computing system that includes one or more computing devices. Additionally, although only a single processing device 502, I/O device 504, and memory 506 are illustratively shown in FIG. 4, it should be appreciated that a particular computing device 500 may include multiple processing devices 502, I/O devices 504, and/or memories 506 in other embodiments. Further, in some embodiments, more than one external device 510 may be in communication with the computing device 500.

Certain embodiments of the present application relate to a method comprising: collecting and storing rainwater in a cistern, thereby providing stored water, wherein the cistern has disposed therein a first cistern heat exchanger such that the first cistern heat exchanger is operable to transfer thermal energy between the stored water and a first refrigerant flowing through the first cistern heat exchanger, and wherein the cistern has disposed therein a second cistern heat exchanger such that the second cistern heat exchanger is operable to transfer thermal energy between the stored water and a second refrigerant flowing through the second cistern heat exchanger; selectively operating a primary heat pump loop in a first mode, the primary heat pump loop comprising a first compressor operable to compress the first refrigerant, an indoor heat exchanger positioned in a building and in thermal communication with an indoor medium, a first expander operable to expand the first refrigerant, and the first cistern heat exchanger, wherein operating the primary heat pump loop in the first mode comprises flowing the first refrigerant through the primary heat pump loop such that the first refrigerant transfers thermal energy between the stored water and the indoor medium; and selectively operating a secondary heat pump loop, the secondary heat pump comprising a second compressor operable to compress the second refrigerant, an outdoor heat exchanger in thermal communication with an outdoor medium, a second expander operable to expand the second refrigerant, and the second cistern heat exchanger, wherein operating the secondary heat pump comprises flowing the second refrigerant through the secondary heat pump loop such that the second refrigerant transfers thermal energy between the stored water and the outdoor medium.

In certain embodiments, collecting and storing rainwater in the cistern comprises directing rainwater from a roof of the building into the cistern.

In certain embodiments, the method further comprises: monitoring an outdoor air temperature of outdoor air; monitoring a stored water temperature of the stored water; and performing an action based upon a comparison of the outdoor air temperature with the stored water temperature. In certain embodiments, performing the action comprises discharging at least a portion of the stored water in response to the stored water temperature being within a predetermined range of the outdoor air temperature. In certain embodiments, performing the action comprises flowing mains water into the cistern in response to the stored water temperature being within a predetermined range of the outdoor air temperature.

In certain embodiments, selectively operating the secondary heat pump loop comprises restricting operation of the secondary heat pump loop to off-peak hours.

In certain embodiments, selectively operating the secondary heat pump loop comprises operating the secondary heat pump loop based upon a weather forecast.

In certain embodiments, the method further comprises selectively operating the primary heat pump loop in a second mode; wherein the primary heat pump loop further comprises a second outdoor heat exchanger in thermal communication with the outdoor medium and a valve system operable to selectively direct the first refrigerant through each of the first cistern heat exchanger and the second outdoor heat exchanger; wherein operating the primary heat pump loop in the first mode comprises setting the valve system to direct the refrigerant through the first cistern heat exchanger to thereby transfer thermal energy between the stored water and the indoor medium; and wherein operating the primary heat pump loop in the second mode comprises setting the valve system to direct the refrigerant through the second outdoor heat exchanger to thereby transfer thermal energy between the outdoor medium and the indoor medium. In certain embodiments, the method further comprises selecting one of the first mode or the second mode based upon a comparison of a temperature of the stored water with a temperature of the outdoor medium.

In certain embodiments, the method further comprises: pumping at least a portion of the stored water to a roof of the building; spraying the pumped water onto the roof such that thermal energy is transferred between the roof and the sprayed water; and returning the water to the cistern via a downspout, thereby altering an average temperature of the stored water.

Certain embodiments of the present application relate to a method comprising: collecting and storing rainwater in a cistern, thereby providing stored water, wherein the cistern has disposed therein a cistern heat exchanger such that the cistern heat exchanger is operable to transfer thermal energy between the stored water and a refrigerant flowing through the first cistern heat exchanger; selectively operating a heat pump loop in a first mode to transfer thermal energy between the stored water and an indoor medium via the refrigerant; and selectively operating the heat pump loop in a second mode to transfer thermal energy between the indoor medium and an outdoor medium via the refrigerant; wherein the heat pump loop comprises a compressor operable to compress the refrigerant, an indoor heat exchanger positioned in a building and in thermal communication with the indoor medium, an expander operable to expand the refrigerant, the cistern heat exchanger, an outdoor heat exchanger connected in parallel with the cistern heat exchanger, and a valve system operable to selectively direct the refrigerant through each of the cistern heat exchanger and the outdoor heat exchanger; wherein operating the heat pump loop in the first mode comprises setting the valve system to direct the refrigerant through the cistern heat exchanger, and operating the compressor such that the refrigerant flows through the heat pump loop and transfers thermal energy between the stored water and the medium; and wherein operating the heat pump loop in the second mode comprises setting the valve system to direct the refrigerant through the outdoor heat exchanger, and operating the compressor such that the refrigerant flows through the heat pump loop and transfers thermal energy between the outdoor medium and the indoor medium.

In certain embodiments, the method further comprises selecting one of the first mode or the second mode based upon a weather forecast.

In certain embodiments, the method further comprises selecting one of the first mode or the second mode based upon a comparison of a temperature of the stored water and a temperature of the outdoor medium.

In certain embodiments, the method further comprises selectively operating a secondary heat pump loop to transfer thermal energy between the stored water and the outdoor medium.

In certain embodiments, selectively operating the secondary heat pump loop comprises restricting operation of the secondary heat pump loop to off-peak hours.

Certain embodiments of the present application relate to a method comprising: collecting and storing rainwater in a cistern, thereby providing stored water, wherein the cistern has disposed therein a cistern heat exchanger such that the cistern heat exchanger is operable to transfer thermal energy between the stored water and a refrigerant flowing through the first cistern heat exchanger; selectively operating a heat pump loop to transfer thermal energy between the stored water and an indoor medium via the refrigerant, wherein the heat pump loop comprises the cistern heat exchanger, a compressor operable to compress the refrigerant, an indoor heat exchanger positioned in a building and in thermal communication with the indoor medium, and an expander operable to expand the refrigerant; and selectively discharging stored water from the cistern based at least in part upon a temperature of the stored water and/or a weather forecast.

In certain embodiments, the method further comprises irrigating land with the discharged water.

In certain embodiments, discharging the stored water comprises spraying the water onto a roof of a building such that thermal energy is transferred between the roof and the sprayed water; and the method further comprises returning the water to the cistern, thereby altering an average temperature of the stored water.

In certain embodiments, the method further comprises selectively spraying the water onto a roof of a building such that thermal energy is transferred between the roof and the sprayed water and returning the water to the cistern, thereby altering an average temperature of the stored water; wherein the selectively discharging stored water is performed based upon the weather forecast predicting greater than a threshold amount of rain; and wherein the selectively spraying the water is performed based upon the weather forecast predicting less than a threshold amount of rain.

In certain embodiments, the selectively discharging is based upon: a comparison of the temperature of the stored water with a threshold temperature; and a comparison of a rain prediction of the weather forecast with a threshold rainfall.

Certain embodiments of the present application relate to a system comprising: a cistern operable to store collected rainwater; a first heat pump loop through which a first refrigerant flows, the first heat pump loop comprising: a first compressor operable to compress the first refrigerant; an indoor heat exchanger through which the first refrigerant flows during operation of the first heat pump loop in a first mode, wherein the indoor heat exchanger is configured to transfer thermal energy between the first refrigerant and an indoor medium; a first expander configured to cause expansion of the first refrigerant as the first refrigerant flows therethrough; and a first cistern heat exchanger through which the first refrigerant flows during operation of the first heat pump loop, wherein the first cistern heat exchanger is disposed in the cistern and is configured to transfer thermal energy between the first refrigerant and the collected rainwater; and a second heat pump loop through which a second refrigerant flows, the second heat pump loop comprising: a second compressor operable to compress the second refrigerant; an outdoor heat exchanger through which the second refrigerant flows during operation of the second heat pump loop, wherein the outdoor heat exchanger is configured to transfer thermal energy between the second refrigerant and an outdoor medium; a second expander configured to cause expansion of the second refrigerant as the second refrigerant flows therethrough; and a second cistern heat exchanger through which the second refrigerant flows during operation of the second heat pump loop, wherein the second cistern heat exchanger is disposed in the rainwater cistern and is configured to transfer thermal energy between the second refrigerant and the collected rainwater.

In certain embodiments, the system further comprises a control system controlling operation of the first heat pump loop and the second heat pump loop; wherein the control system is configured to selectively operate the first compressor such that the first heat pump loop transfers thermal energy between the stored rainwater and the indoor medium via the first refrigerant; and wherein the control system is configured to selectively operate the second compressor such that the second heat pump loop transfers thermal energy between the stored rainwater and the outdoor medium via the second refrigerant.

In certain embodiments, the control system is in communication with a weather forecast service; and the control system is configured to operate the first heat pump loop and the second heat pump loop based at least in part upon weather forecast information received from the weather forecast service.

In certain embodiments, the system further comprises a spray system including a pump positioned in the cistern, a sprayer mounted to a roof of a building, and a downspout extending between a gutter of the roof and the cistern; wherein the spray system is configured to spray stored water onto the roof to transfer thermal energy between the roof and the sprayed water; wherein the gutter is configured to collect the sprayed water; and wherein the downspout is configured to return the collected water to the cistern.

In certain embodiments, the first heat pump loop further comprises: a second outdoor heat exchanger through which the first refrigerant flows during operation of the first heat pump loop in a second mode, wherein the second outdoor heat exchanger is configured to transfer thermal energy between the first refrigerant and the outdoor medium; and a valve system including at least one valve, wherein the valve system is configured to cause the first refrigerant to flow through the first cistern heat exchanger during operation of the first heat pump loop in the first mode, and wherein the valve system is configured to cause the first refrigerant to flow through the second outdoor heat exchanger during operation of the first heat pump loop in the second mode.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
collecting and storing rainwater in a cistern, thereby providing stored water, wherein the cistern has disposed therein a first cistern heat exchanger such that the first cistern heat exchanger is operable to transfer thermal energy between the stored water and a first refrigerant flowing through the first cistern heat exchanger, and wherein the cistern has disposed therein a second cistern heat exchanger such that the second cistern heat exchanger is operable to transfer thermal energy between the stored water and a second refrigerant flowing through the second cistern heat exchanger;
selectively operating a primary heat pump loop in a first mode, the primary heat pump loop comprising a first compressor operable to compress the first refrigerant, an indoor heat exchanger positioned in a building and in thermal communication with an indoor medium, a first expander operable to expand the first refrigerant, and the first cistern heat exchanger, wherein operating the primary heat pump loop in the first mode comprises flowing the first refrigerant through the primary heat pump loop such that the first refrigerant transfers thermal energy between the stored water and the indoor medium; and
selectively operating a secondary heat pump loop, the secondary heat pump comprising a second compressor operable to compress the second refrigerant, an outdoor heat exchanger in thermal communication with an outdoor medium, a second expander operable to expand the second refrigerant, and the second cistern heat exchanger, wherein operating the secondary heat pump comprises flowing the second refrigerant through the secondary heat pump loop such that the second refrigerant transfers thermal energy between the stored water and the outdoor medium.

2. The method of claim 1, wherein collecting and storing rainwater in the cistern comprises directing rainwater from a roof of the building into the cistern.

3. The method of claim 1, further comprising:
monitoring an outdoor air temperature of outdoor air;
monitoring a stored water temperature of the stored water; and
performing an action based upon a comparison of the outdoor air temperature with the stored water temperature.

4. The method of claim 3, wherein performing the action comprises discharging at least a portion of the stored water in response to the stored water temperature being within a predetermined range of the outdoor air temperature.

5. The method of claim 3, wherein performing the action comprises flowing mains water into the cistern in response to the stored water temperature being within a predetermined range of the outdoor air temperature.

6. The method of claim 1, wherein selectively operating the secondary heat pump loop comprises restricting operation of the secondary heat pump loop to off-peak hours.

7. The method of claim 1, wherein selectively operating the secondary heat pump loop comprises operating the secondary heat pump loop based upon a weather forecast.

8. The method of claim 1, further comprising selectively operating the primary heat pump loop in a second mode;
wherein the primary heat pump loop further comprises a second outdoor heat exchanger in thermal communication with the outdoor medium and a valve system operable to selectively direct the first refrigerant through each of the first cistern heat exchanger and the second outdoor heat exchanger;
wherein operating the primary heat pump loop in the first mode comprises setting the valve system to direct the refrigerant through the first cistern heat exchanger to thereby transfer thermal energy between the stored water and the indoor medium; and
wherein operating the primary heat pump loop in the second mode comprises setting the valve system to direct the refrigerant through the second outdoor heat exchanger to thereby transfer thermal energy between the outdoor medium and the indoor medium.

9. The method of claim 8, further comprising selecting one of the first mode or the second mode based upon a comparison of a temperature of the stored water with a temperature of the outdoor medium.

10. The method of claim 1, further comprising:
spraying at least a portion of the stored water onto a roof of a building such that thermal energy is transferred between the roof and the sprayed water; and
returning the water to the cistern, thereby altering an average temperature of the stored water.

11. A method, comprising:
collecting and storing rainwater in a cistern, thereby providing stored water, wherein the cistern has disposed therein a cistern heat exchanger such that the cistern heat exchanger is operable to transfer thermal energy between the stored water and a refrigerant flowing through the first cistern heat exchanger;
selectively operating a heat pump loop in a first mode to transfer thermal energy between the stored water and an indoor medium via the refrigerant; and
selectively operating the heat pump loop in a second mode to transfer thermal energy between the indoor medium and an outdoor medium via the refrigerant;
wherein the heat pump loop comprises a compressor operable to compress the refrigerant, an indoor heat exchanger positioned in a building and in thermal communication with the indoor medium, an expander operable to expand the refrigerant, the cistern heat exchanger, an outdoor heat exchanger connected in parallel with the cistern heat exchanger, and a valve system operable to selectively direct the refrigerant through each of the cistern heat exchanger and the outdoor heat exchanger;
wherein operating the heat pump loop in the first mode comprises:
setting the valve system to direct the refrigerant through the cistern heat exchanger; and
operating the compressor such that the refrigerant flows through the heat pump loop and transfers thermal energy between the stored water and the medium; and
wherein operating the heat pump loop in the second mode comprises:
setting the valve system to direct the refrigerant through the outdoor heat exchanger; and
operating the compressor such that the refrigerant flows through the heat pump loop and transfers thermal energy between the outdoor medium and the indoor medium.

12. The method of claim 11, further comprising selecting one of the first mode or the second mode based upon a weather forecast.

13. The method of claim 11, further comprising selecting one of the first mode or the second mode based upon a comparison of a temperature of the stored water and a temperature of the outdoor medium.

14. The method of claim 11, further comprising selectively operating a secondary heat pump loop to transfer thermal energy between the stored water and the outdoor medium.

15. The method of claim 14, wherein selectively operating the secondary heat pump loop comprises restricting operation of the secondary heat pump loop to off-peak hours.

16. A method, comprising:
collecting and storing rainwater in a cistern, thereby providing stored water, wherein the cistern has disposed therein a cistern heat exchanger such that the cistern heat exchanger is operable to transfer thermal energy between the stored water and a refrigerant flowing through the first cistern heat exchanger;
selectively operating a heat pump loop to transfer thermal energy between the stored water and an indoor medium via the refrigerant, wherein the heat pump loop comprises the cistern heat exchanger, a compressor operable to compress the refrigerant, an indoor heat exchanger positioned in a building and in thermal communication with the indoor medium, and an expander operable to expand the refrigerant; and
selectively discharging stored water from the cistern based at least in part upon a temperature of the stored water and/or a weather forecast.

17. The method of claim 16, further comprising irrigating land with the discharged water.

18. The method of claim 16, wherein discharging the stored water comprises spraying the water onto a roof of a building such that thermal energy is transferred between the roof and the sprayed water; and
wherein the method further comprises returning the water to the cistern, thereby altering an average temperature of the stored water.

19. The method of claim 16, further comprising selectively spraying the water onto a roof of a building such that thermal energy is transferred between the roof and the sprayed water and returning the water to the cistern, thereby altering an average temperature of the stored water;
wherein the selectively discharging stored water is performed based upon the weather forecast predicting greater than a threshold amount of precipitation; and
wherein the selectively spraying the water is performed based upon the weather forecast predicting less than the threshold amount of precipitation.

20. The method of claim 16, wherein the selectively discharging is based upon:
a comparison of the temperature of the stored water with a threshold temperature; and
a comparison of a precipitation prediction of the weather forecast with a threshold precipitation.
